(19) United States
(12) Patent Application Publication
(10) Pub. No.: US 2026/0038991 A1
(43) Pub. Date: Feb. 5, 2026

(54) SECONDARY BATTERY

(71) Applicant: SAMSUNG SDI CO., LTD., Yongin-si (KR)

(72) Inventor: Taewoong JANG, Yongin-si (KR)

(21) Appl. No.: 19/001,870

(22) Filed: Dec. 26, 2024

(30) Foreign Application Priority Data
Aug. 5, 2024 (KR) 10-2024-0103842

(51) Int. Cl. H01M 50/567; H01M 50/153; H01M 50/531; H01M 50/586; H01M 50/588

(52) U.S. Cl. CPC H01M 50/567; H01M 50/153; H01M 50/531; H01M 50/586; H01M 50/588

(57) ABSTRACT

A secondary battery includes an electrode assembly including a first electrode, a separator, and a second electrode, a case accommodating the electrode assembly, the case being electrically connected to the second electrode, and a cap assembly closing an opening of the case, the cap assembly being electrically connected to the first electrode, and the cap assembly including a first fastening portion connectable to a first external terminal.

### CROSS-REFERENCE TO RELATED APPLICATION

The present application claims priority to and the benefit of Korean Application No. 10-2024-0103842, filed on Aug. 5, 2024, in the Korean Intellectual Property Office, the entire disclosure of which is incorporated by reference herein.

### BACKGROUND

### 1. Field

Aspects of embodiments of the present disclosure relate to a secondary battery.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

According to one or more embodiments of the present disclosure, a secondary battery may include an electrode assembly including a first electrode, a separator, and a second electrode, a case configured to accommodate the electrode assembly and electrically connected to the second electrode, and a cap assembly configured to close an opening of the case. The cap assembly may be electrically connected to the first electrode. The cap assembly may include a first fastening portion that may be fastened to a first external terminal.

In some embodiments, the cap assembly may include a cap plate configured to have a through hole formed therein and joined to the case, and a terminal plate that may be disposed inside the cap plate and may be connected to the first electrode. The terminal plate may include the first fastening portion. The cap assembly further comprises an inner insulator disposed between the cap plate and the terminal plate, and an outer insulator configured to cover the through hole and disposed on an outer surface of the cap plate.

In some embodiments, the terminal plate may include a base plate disposed on an inner side of the cap plate and configured to have an inner surface connected to the first electrode. The first fastening portion may be configured to protrude from an outer surface of the base plate, inserted into the through hole, and fastened to the first external terminal.

In some embodiments, the first fastening portion may be formed so that a width thereof increases toward an outer end from the base plate and may include a concave portion formed at an inner end.

In some embodiments, the first fastening portion may be inserted into the first external terminal, and an elastic member provided on an inner circumferential surface of the first external terminal may be fastened to the concave portion.

In some embodiments, the terminal plate may include a base plate disposed on an inner side of the cap plate and configured to have an inner surface connected to the first electrode, and a protrusion configured to protrude from an outer surface of the base plate and inserted into the through hole. The first fastening portion may be recessed inward from the protrusion and into which the first external terminal may be inserted.

In some embodiments, the first fastening portion may be formed so that a width thereof increases from an outer surface to an inner side of the protrusion and may include a concave portion formed at an inner end.

In some embodiments, the first external terminal may be inserted into the first fastening portion, and an elastic member provided on an outer circumferential surface of the first external terminal may be fastened to the concave portion.

In some embodiments, the cap assembly may include a cap plate configured to have a through hole formed therein and joined to the case, and a terminal plate that may be disposed outside the cap plate and may be connected to the first electrode. The terminal plate may include the first fastening portion. The cap assembly may further include an outer insulator disposed between the cap plate and the terminal plate, and an inner insulator disposed on an inner surface of the cap plate.

In some embodiments, the terminal plate may include a base plate disposed outside the cap plate, a protrusion configured to protrude from an inner surface of the base plate, inserted into the through hole, and connected to the first electrode, and an insertion groove recessed toward the protrusion on an outer surface of the base plate. The first fastening portion may be configured to protrude from the insertion groove and fastened to the first external terminal.

In some embodiments, the first fastening portion may be formed so that a width thereof increases toward an outer end from the insertion groove and may include a concave portion formed at an inner end.

In some embodiments, the first fastening portion may be inserted into the first external terminal, and an elastic member provided on an inner circumferential surface of the first external terminal may be fastened to the concave portion.

In some embodiments, the terminal plate may include a base plate disposed outside the cap plate, and a protrusion configured to protrude from an inner surface of the base plate, inserted into the through hole, and connected to the first electrode. The first fastening portion may be recessed inward from an outer surface of the base plate and into which the first external terminal may be inserted.

In some embodiments, the first fastening portion may be formed so that a width thereof increases from an outer surface of the base plate toward an inner side and may include a concave portion formed at an inner end.

In some embodiments, the first external terminal may be inserted into the first fastening portion, and an elastic member provided on an outer circumferential surface of the first external terminal may be fastened to the concave portion.

In some embodiments, the case may include an insertion groove recessed inward from an outer surface of the bottom portion, and a second fastening portion configured to protrude from the insertion groove and fastened to the second external terminal.

In some embodiments, the second fastening portion may be formed so that a width thereof increases toward an outer end from the insertion groove and may include a concave portion formed at an inner end.

In some embodiments, the second fastening portion may be formed at a height that does not protrude from the outer surface of the bottom portion.

In some embodiments, the case may include a second fastening portion recessed inward from an outer surface of the bottom portion and into which the second external terminal may be inserted.

In some embodiments, the second fastening portion may be formed so that a width thereof increases from an outer surface to an inner side of the bottom portion and may include a concave portion formed at an inner end.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a cross-sectional view of an example of a secondary battery according to some embodiments of the present disclosure.

FIG. 2 illustrates a partially exploded cross-sectional view of an example of a secondary battery according to some embodiments of the present disclosure.

FIG. 3 illustrates a cross-sectional view of an example of connecting an external terminal to a secondary battery according to some embodiments of the present disclosure.

FIG. 4 illustrates a perspective view of an example of a configuration for connecting an external terminal to a secondary battery according to some embodiments of the present disclosure.

FIG. 5 illustrates an enlarged cross-sectional view of an example of a state in which an external terminal is connected to a secondary battery according to some embodiments of the present disclosure.

FIG. 6 illustrates a cross-sectional view of another example of a fastening portion to which an external terminal is connected in a secondary battery according to some embodiments of the present disclosure.

FIG. 7 illustrates an enlarged cross-sectional view of an example of a state in which an external terminal is connected to the secondary battery in FIG. 6.

FIGS. 8 and 9 illustrate cross-sectional views of another example in which an external terminal is connected to a case in a secondary battery according to some embodiments of the present disclosure.

FIG. 10 illustrates a cross-sectional view of an example of a secondary battery according to another embodiment of the present disclosure.

FIG. 11 illustrates a cross-sectional view of another example of a fastening portion to which an external terminal is connected in a secondary battery according to another embodiment of the present disclosure.

FIGS. 12 and 13 illustrate cross-sectional views of another example in which an external terminal is connected to a case in a secondary battery according to another embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (or under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

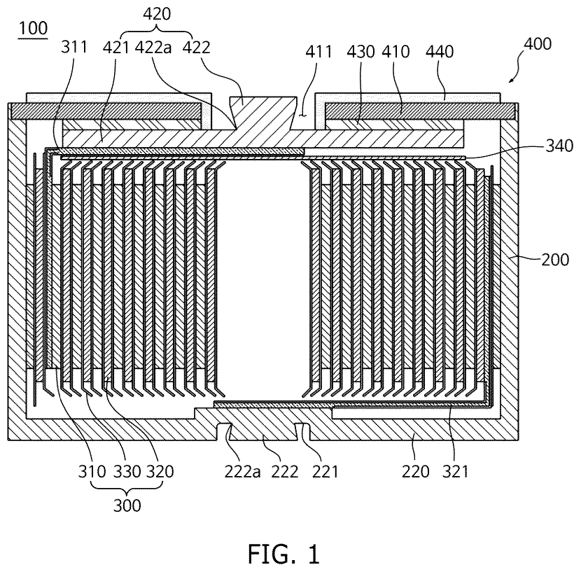

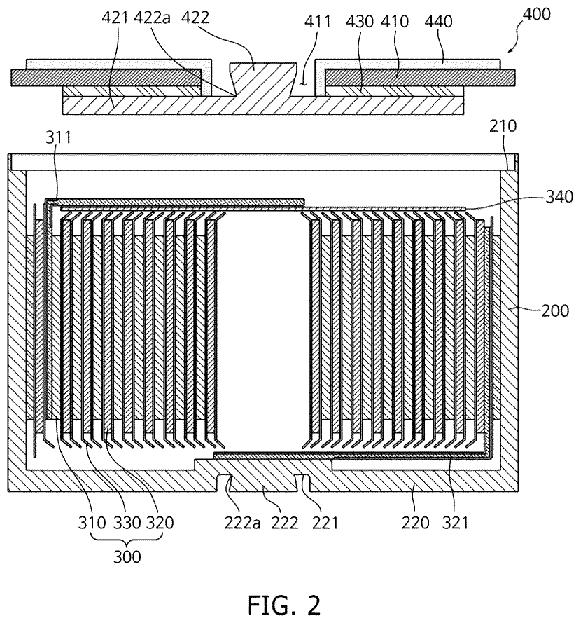

FIG. 1 illustrates a cross-sectional view showing an example of a secondary battery according to some embodiments of the present disclosure, and FIG. 2 illustrates a partially exploded cross-sectional view showing an example of the secondary battery according to some embodiments of the present disclosure.

Referring to FIGS. 1 and 2, a secondary battery 100 according to some embodiments of the present disclosure may include an electrode assembly 300 including a first electrode 310, a separator 330, and a second electrode 320, a case 200 accommodating the electrode assembly 300 and electrically connected to the second electrode 320, and a cap assembly 400 closing an opening of the case 200. The cap assembly 400 may be electrically connected to the first electrode 310. The cap assembly 400 may include a first fastening portion 422 that may be fastened (e.g., fastenable or connectable) to an external terminal.

The electrode assembly 300 may include a separator 330 and a first electrode 310 and a second electrode 320 positioned with the separator 330 interposed therebetween and may be wound in a jelly-roll shape.

The first electrode 310 includes a first substrate and a first active material layer on the first substrate. A first electrode tab 311 may extend outwardly from a first uncoated portion of the first substrate at where the first active material layer is not located, and the first electrode tab 311 may be electrically connected to the cap assembly 400.

The second electrode 320 includes a second substrate and a second active material layer on the second substrate. A second electrode tab 321 may extend outwardly from a second uncoated portion of the second substrate at where the second active material layer is not located, and the second electrode tab 321 may be electrically connected to the case 200. The first electrode tab 311 and the second electrode tab 321 may extend in opposite directions.

The first electrode 310 may act as a positive electrode. In such some embodiments, the first substrate may be made of, for example, an aluminum foil, and the first active material layer may include, for example, a transition metal oxide. The second electrode 320 may act as a negative electrode. In such some embodiments, the second substrate may be made of, for example, a copper foil or a nickel foil, and the second active material layer may include graphite, for example.

The separator 330 prevents a short circuit between the first electrode 310 and the second electrode 320 while allowing movement of lithium ions therebetween. The separator 330 may be made of, for example, a polyethylene film, a polypropylene film, a polyethylene-polypropylene film, or the like.

The case 200 accommodates the electrode assembly 300 and, together with the cap assembly 400, forms the external appearance of the secondary battery. The case 200 may have a substantially cylindrical body portion and a bottom portion connected to one side (e.g., to one end) of the body portion. The case 200 may be made of a metal, such as aluminum, aluminum alloy, or nickel-plated steel. The second electrode tab 321 may be attached and electrically connected to the bottom of the case 200.

The cap assembly 400 may be installed in the opening of the case 200, after the electrode assembly 300 is accommodated in the case 200, and may close the opening of the case 200. In some embodiments, the cap assembly 400 may include a cap plate 410 having a through hole 411 formed therein and coupled to the case 200, a terminal plate 420 disposed on the inner side of the cap plate 410 (e.g., on an inner surface of the cap plate 410 facing the electrode assembly 300) and connected to the first electrode 310 and including a first fastening portion 422, an inner insulator 430 disposed between the cap plate 410 and the terminal plate 420, and an outer insulator 440 covering the through hole 411 and disposed on the outer surface of the cap plate 410.

For example, the cap plate 410 may be formed in a disk shape with the through hole 411 formed in the center of the disk. The cap plate 410 may be formed to have a larger diameter (e.g., outer diameter) than an outer diameter of each of the terminal plate 420 and the inner insulator 430. The cap plate 410 may be inserted into a fastening groove 210 formed in the upper end of the case 200 to close the opening of the case 200, e.g., so the cap plate 410 may be coupled (e.g., connected) to the case 200. In another example, the shape of the cap plate 410 may be formed in various shapes corresponding to the shape of the case 200 to which the cap plate 410 may be fastened.

The terminal plate 420 may include a base plate 421 disposed on the inner side of the cap plate 410 and connected to the first electrode 310, and a first fastening portion 422 protruding from the base plate 421 and inserted into the through hole 411 of the cap plate 410. For example, the base plate 421 may be centered with respect to the cap plate 410, and the first fastening portion 422 may be centered with respect to the through hole 411 of the cap plate 410.

For example, the base plate 421 may be formed in a disk shape having a smaller diameter than the outer diameter of the cap plate 410. In another example, the shape of the base plate 421 may be formed in various shapes corresponding to the shape of the cap plate 410. The inner surface of the base plate 421 may be disposed to face the electrode assembly 300 so that the first electrode tab 311 may be connected thereto. An insulating sheet 340 that electrically insulates the first electrode tab 311 and the electrode assembly 300, while the first electrode tab 311 may be connected to the base plate 421, may be provided between the first electrode tab 311 and the electrode assembly 300.

The configuration in which the base plate 421 and the electrode assembly 300 are electrically connected may vary depending on the shape of the electrode assembly 300. For example, in an example in which the first electrode of the electrode assembly and the base plate 421 may be electrically connected, in a case where opposite surfaces of the electrode assembly are formed in a form where an uncoated portion may be pressed, the uncoated portion of the electrode assembly and the inner surface of the base plate 421 may be connected by surface contact.

The first electrode tab 311 may be connected to the base plate 421, and the second electrode tab 321 may be connected to the case 200, so that the terminal plate 420 may function as the positive electrode and the case 200 may function as the negative electrode, e.g., it may also be configured to have reverse electrodes.

The inner insulator 430 may be disposed between the cap plate 410 and the terminal plate 420 to electrically insulate the cap plate 410 and the terminal plate 420. The cap plate 410 and the terminal plate 420 may be formed of a conductive metal material and may be electrically connected to the negative electrode, which may be the second electrode tab 321, and the positive electrode, which may be the first electrode tab 311, respectively. The inner insulator 430 may prevent a short circuit by insulating the cap plate 410 from the terminal plate 420. The inner insulator 430 may be formed of resin such as polypropylene (PP) or polyethylene (PE).

The inner insulator 430 may be formed in a disk shape with an insertion hole formed in the center, similar to the cap plate 410. In this manner, the first fastening portion 422 of the terminal plate 420 may be disposed to be exposed to the outside by passing through the insertion hole of the inner insulator 430 and the through hole 411 of the cap plate 410. The outer diameter of the inner insulator 430 may be formed to a size equal to/similar to the outer diameter of the base plate 421. The cap plate 410 may be formed to have a larger outer diameter than an outer diameter of each of the inner insulator 430 and the base plate 421. The diameter of the insertion hole of the inner insulator 430 may be formed to have a size equal to/similar to the diameter of the through hole 411 of the cap plate 410, e.g., the diameters of the insertion hole of the inner insulator 430 and the through hole 411 of the cap plate 410 may be aligned to overlap each other.

The inner insulator 430 may be connected to the cap plate 410 and the base plate 421 by a heat-melting method of heating and pressing the cap plate 410 and the base plate 421 while being disposed between the cap plate 410 and the base plate 421.

The outer insulator 440 may be disposed on the outer surface of the cap plate 410 so as to insulate the outer surface of the cap plate 410. The outer insulator 440 may, e.g., continuously, cover the inner circumferential surface of the through hole 411 so as to insulate the external terminal fastened to the first fastening portion 422. For connection with the external terminal, the first fastening portion 422 may be formed to have a width that increases toward the outer end from the base plate 421 (e.g., a width increasing in a direction oriented from the base plate 421 toward the cap plate 410) and may include a concave portion 422a formed at the inner end (e.g., a portion that curves inwardly into the first fastening portion 422 at a contact point between the base plate 421 and the first fastening portion 422).

In a case where the cap plate 410 is connected to the case 200 and functions as the negative electrode, which may be the same electrode as the case 200, the first fastening portion 422 functions as the positive electrode. Thus, the outer insulator 440 may prevent a short circuit from occurring by insulating the external terminal fastened to the first fastening portion 422 from the cap plate 410. The outer insulator 440 may be formed of resin such as polypropylene (PP) or polyethylene (PE).

For example, the battery (e.g., the secondary battery 100) described with reference to FIG. 1 may be a coin cell or a button cell. In another example, the present disclosure may be applied to other types of secondary batteries (e.g., cylindrical batteries). In FIG. 1, while the first electrode tab 311 is illustrated as protruding upward and connected to the cap assembly 419 and the second electrode tab 321 is illustrated as protruding downward and connected to the case 200, both the first electrode tab and the second electrode tab may be configured in a form in which the first electrode tab and the second electrode tab protrude upward and are connected to the cap assembly and the case.

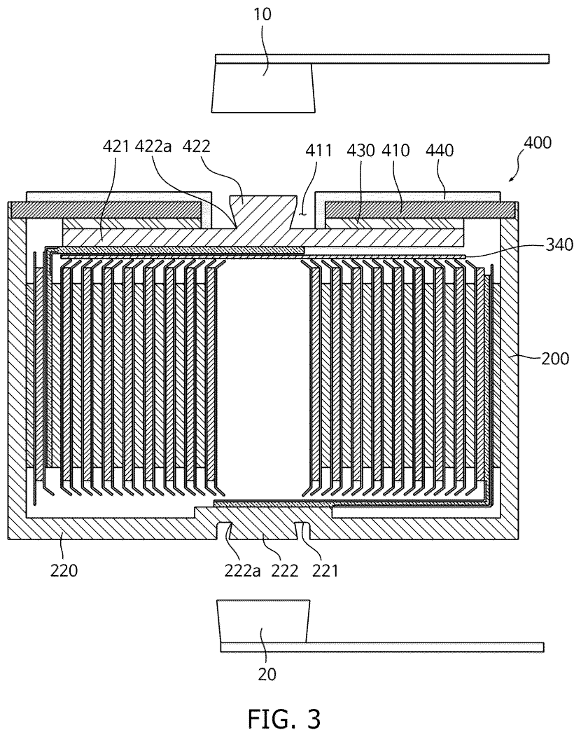

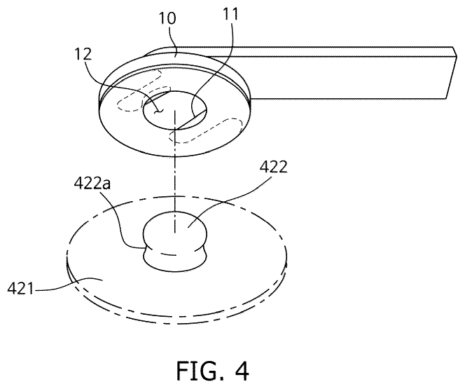

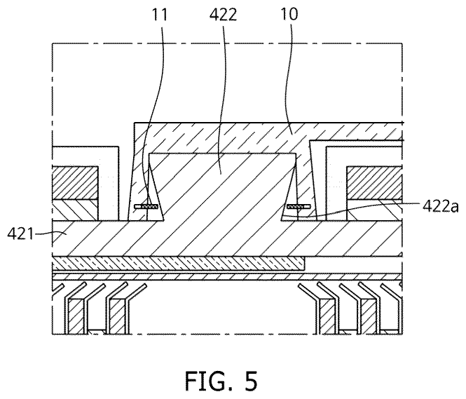

FIG. 3 illustrates a cross-sectional view showing an example of connecting an external terminal to a secondary battery according to some embodiments of the present disclosure, FIG. 4 illustrates a perspective view showing an example of a configuration for connecting the external terminal to the secondary battery according to some embodiments of the present disclosure, and FIG. 5 illustrates an enlarged cross-sectional view showing an example of a state in which the external terminal is connected to the secondary battery according to some embodiments of the present disclosure.

Referring to FIGS. 3 to 5, the first fastening portion 422 according to some embodiments of the present disclosure may be exposed to the outside of the cap plate 410 while protruding from the outer surface of the base plate 421 and inserted into the through hole 411. A first external terminal 10 may be fastened to the first fastening portion 422.

In some embodiments, the first fastening portion 422 may be formed to have a width that increases toward the outer end from the base plate 421 and may include a concave portion 422a formed at the inner end. For example, referring to FIG. 3, an uppermost width of the first fastening portion 422 (e.g., at an upper surface of the first fastening portion 422 facing away from the electrode assembly 300) may be wider than a lowermost width of the first fastening portion 422 (e.g., at an imaginary connection line between the first fastening portion 422 and the base plate 421). Referring to FIG. 4, the first external terminal 10 fastened to the first fastening portion 422 may include an insertion hole 12 into which the first fastening portion 422 may be inserted, and an elastic member 11 that may be partially disposed inside the insertion hole 12 and provides elasticity.

The first fastening portion 422 may be formed at a height that does not protrude from the outer surface of the cap plate 410 or the outer insulator 440. If the first fastening portion 422 were to be formed at a protruding height (e.g., to extend beyond or above the cap plate 410 or the outer insulator 440), the load may be concentrated on the first fastening portion 422 in a case where an external force may be applied, which may easily cause damage. Therefore, the first fastening portion 422 may be formed at a height that does not protrude from the outside of the cap plate 410 or the outer insulator 440. When necessary, the first fastening portion 422 may be formed to protrude toward the outer surface of the cap plate 410 or the outer insulator 440.

With this configuration, in a case where the first fastening portion 422 is inserted (e.g., insertable) into the insertion hole 12 of the first external terminal 10, the elastic member 11 may be deformed by the pressing force of the first fastening portion 422, and the first fastening portion 422 may be inserted into the insertion hole 12. While the first fastening portion 422 is inserted into the insertion hole 12, the elastic member 11 may be elastically restored and caught by the concave portion 422a. In this manner, the first external terminal 10 may be fastened to the first fastening portion 422. In some embodiments, in a case where an external force is applied to the first external terminal 10 in a direction that releases from the first fastening portion 422, the first external terminal 10 may be separated from the first fastening portion 422.

According to some embodiments of the present disclosure, referring to FIG. 3, the case 200 may include an insertion groove 221 that may be recessed inward from an outer surface of a bottom portion 220, and a second fastening portion 222 that protrudes from the insertion groove 221 and may be fastened to a second external terminal 20.

In some embodiments, the second fastening portion 222 may be formed to have a width that increases toward the outer end from the insertion groove 221 and may include a concave portion 222a formed at the inner end. The second external terminal 20 fastened to the second fastening portion 222 may be configured in the same shape as the first external terminal 10 described above and may be fastened in the same manner. The second fastening portion 222 may be formed at a height that does not protrude to the outer surface of the bottom portion 220. In a case where the second fastening portion 222 may be formed at a height that protrudes outward from the bottom portion 220, the load may be concentrated on the second fastening portion 222 in a case where an external force may be applied to the bottom portion 220 of the case 200, which may cause damage. Therefore, the second fastening portion 222 may be formed at a height that does not protrude to the outside of the bottom portion 220. When necessary, the second fastening portion 222 may be formed to protrude to the outer surface of the bottom portion 220.

The first external terminal 10 and the second external terminal 20 may be connection terminals connected to an external device so as to charge and discharge the electrode assembly 300.

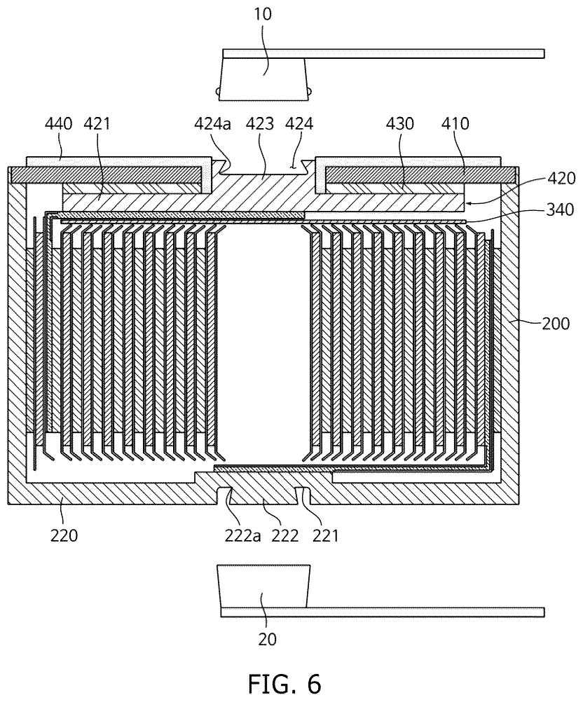

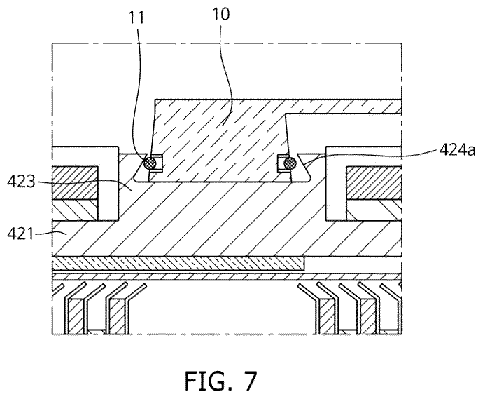

FIG. 6 illustrates a cross-sectional view showing another example of a fastening portion to which an external terminal is connected in a secondary battery according to some embodiments of the present disclosure, and FIG. 7 illustrates an enlarged cross-sectional view showing an example of a state in which the external terminal is connected to the secondary battery according to the embodiment of FIG. 6. With regard to FIGS. 6 and 7, a description may be given focusing on a configuration different from the above-described embodiment.

Referring to FIGS. 6 and 7, a first fastening portion 424 according to some embodiments of the present disclosure may be formed in a groove shape. For example, the first fastening portion 424 may be a groove in the base plate 421 that faces away from the electrode assembly.

In detail, the terminal plate 420 may include the base plate 421 disposed on an inner side of the cap plate 410 and having an inner surface connected to the first electrode 310, a protrusion 423 protruding from the outer surface of the base plate 421 and inserted into the through hole 411, and the first fastening portion 424 recessed inward in the protrusion 423 and into which the first external terminal 10 may be inserted and caught. The first fastening portion 424 may be formed in a groove shape in the protrusion 423 inserted into the through hole 411, and the first external terminal 10 may be inserted into and fastened to the first fastening portion 424.

In some embodiments, the first fastening portion 424 may be formed so that the width thereof increases from the outer surface of the protrusion 423 toward the inner surface of the protrusion 423 (e.g., in a direction oriented from the cap plate 410 toward the base plate 421), and may include a concave portion 424a formed at the inner end. The first external terminal 10 fastened to the first fastening portion 424 may include an elastic member 11 that provides elastic force outward from the body inserted into the first fastening portion 424.

With this configuration, in a case where the first external terminal 10 may be inserted into the first fastening portion 424, the elastic member 11 may be compressed inward by the pressing force of the first fastening portion 424, and the first external terminal 10 may be inserted into the first fastening portion 424. While the first external terminal 10 is inserted into the first fastening portion 424, the elastic member 11 may be elastically restored and caught by the concave portion 424a. In this manner, the first external terminal 10 may be fastened to the first fastening portion 424. In some embodiments, in a case where an external force is applied to the first external terminal 10 in a direction that releases from the first fastening portion 424, the first external terminal 10 may be separated from the first fastening portion 424.

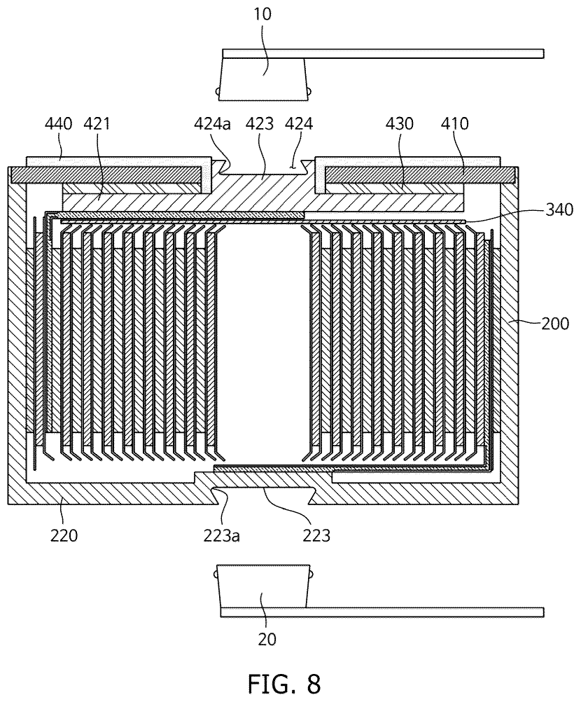

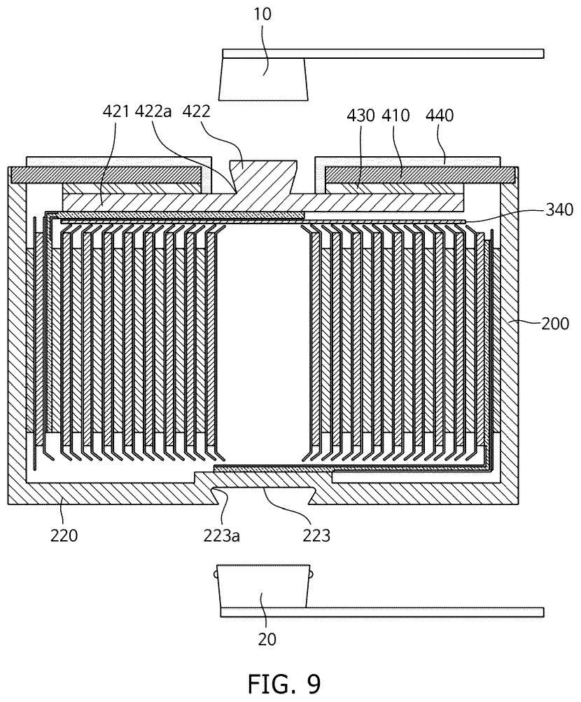

FIGS. 8 and 9 illustrate cross-sectional views showing another example in which an external terminal is connected to a case in a secondary battery according to some embodiments of the present disclosure. With regard to FIGS. 8 and 9, a description may be given focusing on a configuration different from the above-described embodiment.

Referring to FIGS. 8 and 9, the case 200 may include a second fastening portion 223 that may be recessed inward from an outer surface of a bottom portion 220 and into which the second external terminal 20 may be inserted and caught. The second fastening portion 223 may be formed so that the width thereof increases from the outer surface of the bottom portion 220 toward the inner surface of the bottom portion 220, and may include a concave portion 223a formed on the inner end.

As an example, the second external terminal 20 fastened to the second fastening portion 223 may include an elastic member that provides elastic force outward from the body inserted into the second fastening portion 223. The second fastening portion 223 and the second external terminal 20 may be configured in the same groove shape as the first fastening portion 424 and the first external terminal 10 described with reference to FIG. 7.

With this configuration, in the secondary battery of some embodiments of the present disclosure, referring to FIG. 8, the first fastening portion 424 may be formed in a groove shape as described with reference to FIGS. 6 and 7, and the second fastening portion 223 may also be formed in a groove shape in the same manner. As another example, referring to FIG. 9, the first fastening portion 422 may be formed in a protrusion shape as described with reference to FIGS. 3 to 5, and the second fastening portion 223 may be formed in a groove shape.

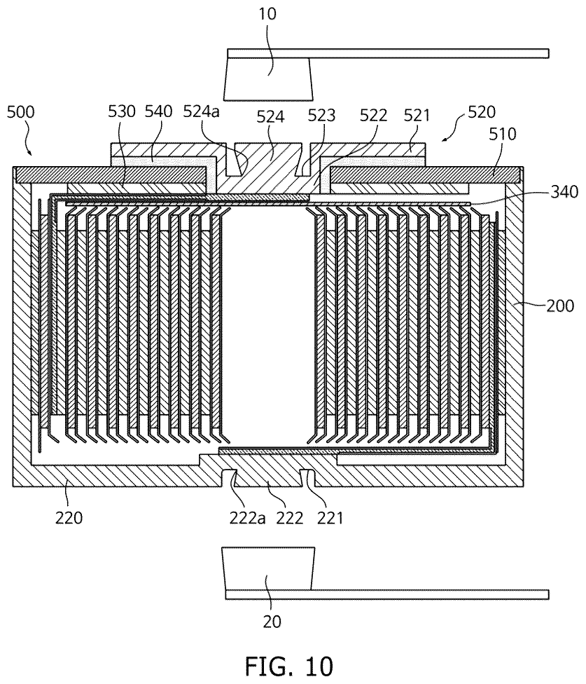

FIG. 10 illustrates a cross-sectional view showing an example of a secondary battery according to another embodiment of the present disclosure. With regard to FIG. 10, a description may be given focusing on a configuration different from the above-described embodiment.

Referring to FIG. 10, a secondary battery according to another embodiment of the present disclosure may have a cap assembly 500 formed in a different shape. In some embodiments, the cap assembly 500 may include a cap plate 510 having a through hole formed therein and coupled to the case 200, a terminal plate 520 disposed on the outer side of the cap plate 510 and connected to the first electrode 310 and including a first fastening portion 524, an outer insulator 540 disposed between the cap plate 510 and the terminal plate 520, and an inner insulator 530 disposed on the inner surface of the cap plate 510.

The cap plate 510 may be formed in a disk shape with the through hole formed in the center. The cap plate 510 may be formed to have a larger diameter than the terminal plate 520 and the outer insulator 540. The cap plate 510 may be formed in the same shape as the cap plate 410 described above with reference to FIG. 1.

The terminal plate 520 may include a first fastening portion 524 disposed on the outer side of the cap plate 510 and to which the first external terminal 10 may be fastened. In some embodiments, the terminal plate 520 may include a base plate 521 disposed on the outer side of the cap plate 510, a protrusion 522 protruding from the inner side of the base plate 521, inserted into a through hole, and connected to the first electrode 310, an insertion groove 523 recessed from the outer side of the base plate 521 toward the protrusion 522, and the first fastening portion 524 protruding from the insertion groove 523 and fastened to the first external terminal 10.

The base plate 521 may be formed in a disk shape having a smaller diameter than the cap plate 510, and the protrusion 522 may be formed at the center so as to be inserted into the through hole of the cap plate 510. The protrusion 522 may be formed to protrude outward from the cap plate 510 while being inserted into the through hole. The protrusion 522 may be configured to protrude toward the electrode assembly 300 and to which the first electrode tab 311 may be attached. The shape of the base plate 521 may be formed in various shapes corresponding to the shape of the cap plate 510. As such, the first electrode tab 311 may be attached to the protrusion 522, and the second electrode tab 321 may be attached to the case 200, so that the terminal plate 520 may function as the positive electrode and the case 200 may function as the negative electrode.

The outer insulator 540 may be disposed between the cap plate 510 and the terminal plate 520 to electrically insulate the cap plate 510 and the terminal plate 520. The cap plate 510 and the terminal plate 520 may be formed of a conductive metal material and are electrically connected to the negative electrode, which may be the second electrode tab 321, and the positive electrode, which may be the first electrode tab 311, respectively, so that the outer insulator 540 may insulate the cap plate 510 and the terminal plate 520 to prevent a short circuit from occurring. The outer insulator 540 may be formed of resin such as polypropylene (PP) or polyethylene (PE).

The inner insulator 530 may be disposed between the cap plate 510 and the first electrode tab 311 to insulate between the cap plate 510 and the first electrode tab 311. In a case where the cap plate 510 is connected to the case 200 and functions as a negative electrode, which may be the same electrode as the case 200, the first electrode tab 311 may function as a positive electrode. Accordingly, the inner insulator 530 may prevent a short circuit from occurring by insulating the cap plate 510 and the first electrode tab 311. The inner insulator 530 may be formed of resin such as polypropylene (PP) or polyethylene (PE).

The insulating sheet 340 may be disposed on the electrode assembly 300 so as to insulate between the upper portion of the electrode assembly 300 and the first electrode tab 311.

The first fastening portion 524 may protrude from the insertion groove 523 recessed toward the protrusion 522 on the outer surface of the base plate 521 and may be exposed to the outside so that the first external terminal 10 may be fastened.

In some embodiments, the first fastening portion 524 may be formed to have a width that increases toward the outer end from the insertion groove 523 and may include a concave portion 524a formed at the inner end. The first fastening portion 524 may be inserted into the first external terminal 10, and an elastic member provided on the inner circumferential surface of the first external terminal 10 may be caught and fastened to the concave portion 524a. The first fastening portion 524 may be configured in the same protrusion shape as the first fastening portion 422 and the first external terminal 10 described with reference to FIG. 5.

The case 200 may include the insertion groove 221 recessed inward from the outer surface of the bottom portion 220, and the second fastening portion 222 protruding from the insertion groove 221 and fastened to the second external terminal 20. In some embodiments, the second fastening portion 222 may be formed to have a width that increases toward the outer end from the insertion groove 221 and may include the concave portion 222a formed at the inner end. The second external terminal 20 fastened to the second fastening portion 222 may be configured in the same shape as the first external terminal 10 described above and may be fastened in the same manner.

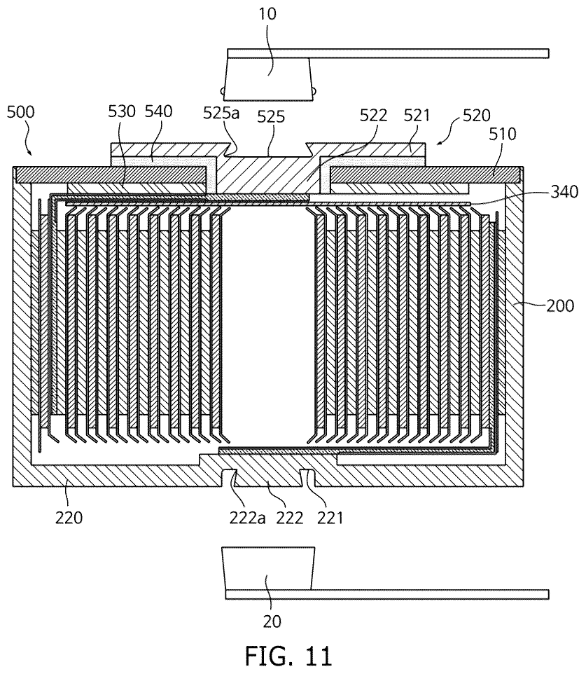

FIG. 11 illustrates a cross-sectional view showing another example of a fastening portion to which an external terminal is connected in a secondary battery according to another embodiment of the present disclosure. With regard to FIG. 11, a description may be given focusing on a configuration different from the above-described embodiment.

Referring to FIG. 11, a first fastening portion 525 according to another embodiment of the present disclosure may be formed in a groove shape. In some embodiments, the terminal plate 520 may include the base plate 521 disposed on the outer side of the cap plate 510, the protrusion 522 protruding from the inner side of the base plate 521, inserted into a through hole, and connected to a first electrode, and the first fastening portion 525 recessed inward from the outer surface of the base plate 521 and into which the first external terminal 10 may be inserted and caught.

In some embodiments, the first fastening portion 525 may be formed to have a width that increases from the outer surface to the inner side of the base plate 521 and may include a concave portion 525a formed at the inner end. The first external terminal 10 fastened to the first fastening portion 525 may include an elastic member that provides elastic force outward from the body inserted into the first fastening portion 525. The first fastening portion 525 and the first external terminal 10 may be configured in the same groove shape as the first fastening portion 424 and the first external terminal 10 described with reference to FIG. 7.

The second fastening portion 222 formed on the bottom portion 220 of the case 200 may be formed in a protrusion shape so that the second external terminal 20 may be fastened. For example, it may be configured in the same shape as the second fastening portion 222 and the second external terminal 20 described with reference to FIG. 10.

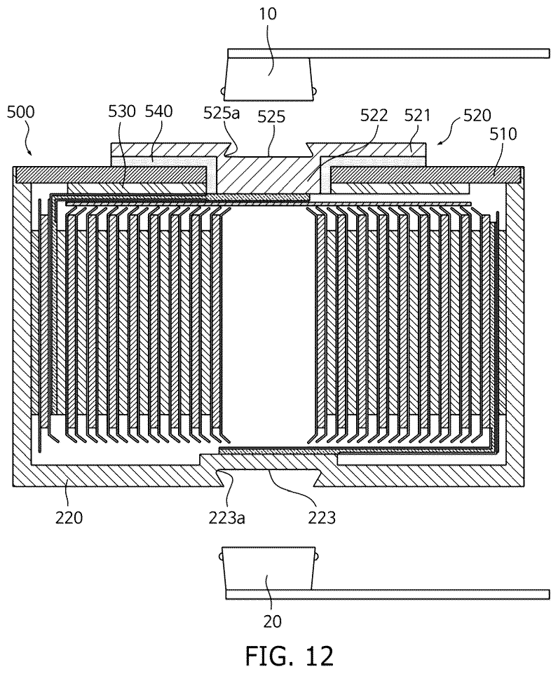

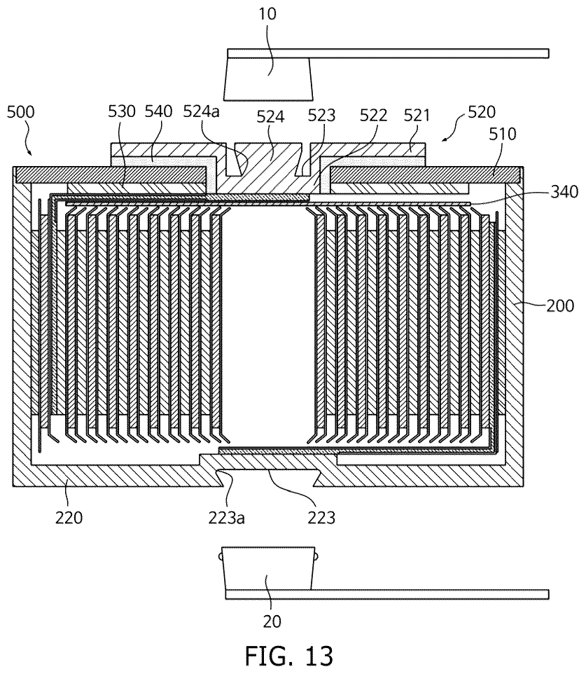

FIGS. 12 and 13 illustrate cross-sectional views showing another example in which an external terminal is connected to a case in a secondary battery according to another embodiment of the present disclosure. With regard to FIGS. 12 and 13, a description may be given focusing on a configuration different from the above-described embodiment.

Referring to FIGS. 12 and 13, the case 200 may include the second fastening portion 223 that may be recessed inward from an outer surface of the bottom portion 220 and into which the second external terminal 20 may be inserted and caught. The second fastening portion 223 may be formed so that the width thereof increases from the outer surface of the bottom portion 220 toward the inner surface of the bottom portion 220, and may include the concave portion 223a formed on the inner end.

In some embodiments, the second external terminal 20 fastened to the second fastening portion 223 may include an elastic member that provides elastic force outward from the body inserted into the second fastening portion 223. The second fastening portion 223 and the second external terminal 20 may be configured in the same groove shape as the first fastening portion 525 and the first external terminal 10 described with reference to FIG. 11.

With this configuration, in the secondary battery of another embodiment of the present disclosure, referring to FIG. 12, the first fastening portion 525 may be formed in a groove shape as described with reference to FIG. 11, and the second fastening portion 223 may also be formed in a groove shape in the same manner. As another example, referring to FIG. 13, the first fastening portion 524 may be formed in a protrusion shape as described with reference to FIG. 10, and the second fastening portion 223 may be formed in a groove shape.

By way of summation and review, in order to connect an external terminal to a secondary battery, the external terminal may be connected to the case through welding. However, in a case where welding is performed on the case, high welding heat may be transferred to the interior of the case, causing damage to the electrode assembly. In contrast, aspects of embodiments of the present disclosure provide a secondary battery connected to the external terminal without welding, thereby preventing damage caused by welding heat.

However, aspects and features of the present disclosure are not limited to those described above, and other aspects and features not mentioned will be clearly understood by a person skilled in the art from the detailed description, described above.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
an electrode assembly including a first electrode, a separator, and a second electrode;
a case accommodating the electrode assembly, the case being electrically connected to the second electrode; and
a cap assembly closing an opening of the case, the cap assembly being electrically connected to the first electrode and including a first fastening portion, and the first fastening portion being connectable to a first external terminal.

2. The secondary battery as claimed in claim 1, wherein the cap assembly further includes:
a cap plate with a through hole, the cap plate being joined to the case;
a terminal plate on the cap plate and connected to the first electrode, the terminal plate including the first fastening portion;
an inner insulator between the cap plate and the terminal plate; and
an outer insulator covering the through hole and an outer surface of the cap plate.

3. The secondary battery as claimed in claim 2, wherein the terminal plate further includes a base plate on an inner side of the cap plate and having an inner surface connected to the first electrode, the first fastening portion protruding from an outer surface of the base plate into the through hole of the cap plate to be connectable to the first external terminal.

4. The secondary battery as claimed in claim 3, wherein the first fastening portion has a width that increases from the base plate toward an outer end of the first fastening portion, the first fastening portion including a concave portion at an inner end thereof.

5. The secondary battery as claimed in claim 4, wherein the first fastening portion is insertable into the first external terminal, an elastic member on an inner circumferential surface of the first external terminal being fastenable to the concave portion.

6. The secondary battery as claimed in claim 2, wherein the terminal plate further includes:
a base plate on an inner side of the cap plate and having an inner surface connected to the first electrode; and
a protrusion protruding from an outer surface of the base plate into the through hole, the first fastening portion being recessed inward from the protrusion, and the first external terminal being insertable into the first fastening portion.

7. The secondary battery as claimed in claim 6, wherein the first fastening portion has a width that increases from an outer surface to an inner side of the protrusion, the first fastening portion including a concave portion at an inner end thereof.

8. The secondary battery as claimed in claim 7, wherein the first external terminal is insertable into the first fastening portion, and an elastic member on an outer circumferential surface of the first external terminal being connectable to the concave portion.

9. The secondary battery as claimed in claim 1, wherein the cap assembly further includes:
a cap plate with a through hole, the cap plate being joined to the case;
a terminal plate outside the cap plate and connected to the first electrode, the terminal plate including the first fastening portion;
an outer insulator between the cap plate and the terminal plate; and
an inner insulator on an inner surface of the cap plate.

10. The secondary battery as claimed in claim 9, wherein the terminal plate includes:
a base plate outside the cap plate;
a protrusion protruding from an inner surface of the base plate into the through hole, the protrusions being connected to the first electrode; and
an insertion groove recessed toward the protrusion on an outer surface of the base plate, the first fastening portion protruding from the insertion groove and being connectable to the first external terminal.

11. The secondary battery as claimed in claim 10, wherein the first fastening portion has a width that increases toward an outer end thereof from the insertion groove and includes a concave portion at an inner end thereof.

12. The secondary battery as claimed in claim 11, wherein the first fastening portion is insertable into the first external terminal, and an elastic member on an inner circumferential surface of the first external terminal is fastenable to the concave portion.

13. The secondary battery as claimed in claim 9, wherein the terminal plate includes:
a base plate outside the cap plate; and
a protrusion protruding from an inner surface of the base plate into the through hole, the protrusion being connected to the first electrode, and the first fastening portion being recessed inward from an outer surface of the base plate toward the protrusion to receive the first external terminal.

14. The secondary battery as claimed in claim 13, wherein the first fastening portion has a width that increases from an outer surface of the base plate toward an inner side of the base plate and includes a concave portion at an inner end thereof.

15. The secondary battery as claimed in claim 14, wherein the first external terminal is insertable into the first fastening portion, and an elastic member on an outer circumferential surface of the first external terminal is fastenable to the concave portion.

16. The secondary battery as claimed in claim 1, wherein the case includes:
an insertion groove recessed inward from an outer surface of a bottom portion of the case; and
a second fastening portion protruding from the insertion groove and fastenable to a second external terminal.

17. The secondary battery as claimed in claim 16, wherein the second fastening portion has a width that increases toward an outer end thereof from the insertion groove and includes a concave portion at an inner end thereof.

18. The secondary battery as claimed in claim 17, wherein the second fastening portion is at a height that does not protrude from the outer surface of the bottom portion.

19. The secondary battery as claimed in claim 1, wherein the case includes a second fastening portion recessed inward from an outer surface of a bottom portion and into which a second external terminal is insertable.

20. The secondary battery as claimed in claim 19, wherein the second fastening portion has a width that increases from an outer surface of the bottom portion toward the electrode assembly and includes a concave portion at an inner end thereof.
